(19) United States
(12) Patent Application Publication
(10) Pub. No.: US 2022/0118603 A1
(43) Pub. Date: Apr. 21, 2022

(54) Variable Stiffness Mechanisms for low Energy Cost Stiffness Modulation

(71) Applicant: VANDERBILT UNIVERSITY, Nashville, TN (US)

(72) Inventors: David Braun, Nashville, TN (US); Sung Kim, Nashville, TN (US)

(21) Appl. No.: 17/506,164

(22) Filed: Oct. 20, 2021

Related U.S. Application Data
(60) Provisional application No. 63/094,309, filed on Oct. 20, 2020.

(51) Int. Cl. B25J 9/00; B25J 19/00; A61G 5/14

(52) U.S. Cl. CPC B25J 9/0006; A61G 5/14; B25J 19/0016

(57) ABSTRACT

Disclosed herein is a variable-stiffness floating spring mechanism. The variable-stiffness floating spring mechanism can change its stiffness without changing an energy stored by a spring. The variable-stiffness floating spring mechanism can amplify an output of a human user. The variable-stiffness floating spring mechanism can enable augmentation of physical performance beyond the physical capabilities of the human user.

### CROSS-REFERENCE TO RELATED APPLICATIONS

This application claims the benefit of U.S. Provisional Application No. 63/094,309, filed Oct. 20, 2020, the entire contents of which is hereby incorporated herein by reference.

### BACKGROUND

A typical spring has constant stiffness that defines how much force it exerts upon deflection. The stiffness of a spring depends on the material, shape, and size of the spring. Variable stiffness springs are a special type of springs that change their shape or size to increase or decrease stiffness, providing more or less force upon the same deflection. Variable stiffness springs enable a range of new capabilities compared to constant stiffness springs, including stable robot-environment interaction, safer human-robot interaction, efficient resonance-based robot actuation, as well as human performance augmentation. However, increasing the stiffness of a spring can be costly because increasing stiffness also increases the energy stored by the spring.

### BRIEF DESCRIPTION OF THE DRAWINGS

For a more complete understanding of the embodiments and the advantages thereof, reference is now made to the following description, in conjunction with the accompanying figures briefly described as follows.

FIGS. 1A and 1B illustrate examples of a variable-stiffness floating spring mechanism, according to various embodiments of the present disclosure.

FIGS. 2A-2D illustrate examples of a work cycle of the variable-stiffness floating spring mechanism, according to various embodiments of the present disclosure.

FIGS. 3A and 3B illustrate examples of measurements from the variable-stiffness floating spring mechanism during the work cycle illustrated in FIGS. 2A-2D, according to various embodiments of the present disclosure.

FIG. 4 illustrates an example of a variable-stiffness floating spring exoskeleton, according to various embodiments of the present disclosure.

FIG. 5 illustrates an example of the variable-stiffness floating spring exoskeleton in a constrained human-device interface, according to various embodiments of the present disclosure.

FIGS. 6A and 6B illustrate examples of the variable-stiffness floating spring exoskeleton used in an exemplary task, according to various embodiments of the present disclosure.

FIGS. 7A and 7B illustrate examples of the variable-stiffness floating spring exoskeleton used in another exemplary task, according to various embodiments of the present disclosure.

FIGS. 8A and 8B illustrate an example of the variable-stiffness floating spring exoskeleton used in another exemplary task.

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions may be exaggerated to help visually convey certain principles. In the drawings, similar reference numerals between figures designate like or corresponding, but not necessarily the same, elements.

### DETAILED DESCRIPTION

Disclosed here is a variable-stiffness floating spring mechanism that can change its stiffness without changing energy stored by the spring. Variable stiffness springs can provide a means for safe human-robot interfacing, efficient actuation, and bio-mimetic human-environment interfacing. Theoretical work has shown that variable stiffness springs could help peak performance augmentation with completely passive exoskeletons, instead of simply decreasing the required human effort. However, current variable stiffness springs exhibit detrimental characteristics that limit their widespread adoption in exoskeletons. These detrimental characteristics can include, for example, a tradeoff between energy storage capacity and the stiffness change, or an inability to change stiffness with negligible energy cost when deflected.

Variable stiffness spring actuators used to drive robots and human assistive and augmentation devices may be characterized by the following feature: increasing stiffness as the spring is deformed costs more energy because it results in more energy stored by the spring. This feature imposes an apparently fundamental limitation on variable stiffness spring actuation in demanding tasks, such as lifting more, jumping higher, or running faster, because, in all these tasks the variable stiffness spring should store a considerable amount of energy and provide different stiffnesses to accommodate different weights in lifting, heights in jumping, and speeds in running.

Due to the inherent coupling between the stiffness and the energy stored by a spring, increasing stiffness costs a significant amount of energy, proportional to the energy stored by the spring. The new capabilities offered by variable stiffness springs compared to fixed stiffness springs come at a high energy cost.

The disclosed variable-stiffness floating spring mechanism is not subject to such pitfalls and enables effective augmentation of human physical performance. The energy cost of changing the stiffness of the variable-stiffness floating spring mechanism can be independent of the energy stored by the spring. The variable-stiffness floating spring mechanism can serve as a component of new generation variable stiffness robots, industrial robots, medical robots, prosthetics, assistive devices, human performance augmenting exoskeletons, vehicle suspension systems, legged chairs, cars, and other applications. The variable-stiffness floating spring mechanism can provide the benefit of stiffness adaptation without powerful motors or hefty battery packs, thereby reducing the bulk and weight of these mechanically adaptive machines.

The variable-stiffness floating spring mechanism can be used in an exoskeleton that can provide a safe interface to aid humans in performing demanding tasks that may exceed their physical capabilities. For example, the variable-stiffness floating spring exoskeleton can aid humans in transporting heavy objects, lifting human bodies in medical or rescue scenarios, transitioning from a sitting position to a standing position for physically impaired persons, or other tasks that may exceed typical human physical capabilities. The aid provided by the variable-stiffness floating spring exoskeleton can likewise reduce the possibility of injuries related to such tasks.

In the following paragraphs, the embodiments are described in further detail by way of example with reference to the attached drawings. In the description, well-known components, methods, and/or processing techniques are omitted or briefly described so as not to obscure the embodiments. As used herein, the “present disclosure” refers to any one of the embodiments described herein and any equivalents. Furthermore, reference to various feature(s) of the “present embodiment” is not to suggest that all embodiments must include the referenced feature(s).

The embodiments described herein are not limited in application to the details set forth in the following description or illustrated in the drawings. The disclosed subject matter is capable of other embodiments and of being practiced or carried out in various ways. Also, the phraseology and terminology used herein is for the purpose of description and should not be regarded as limiting. The use of “including,” “comprising,” or “having” and variations thereof herein is meant to encompass the items listed thereafter, additional items, and equivalents thereof. The terms “connected” and “coupled” are used broadly and encompass both direct and indirect connections and couplings. In addition, the terms “connected” and “coupled” are not limited to electrical, physical, or mechanical connections or couplings. Turning now to the drawings, exemplary embodiments are described in detail.

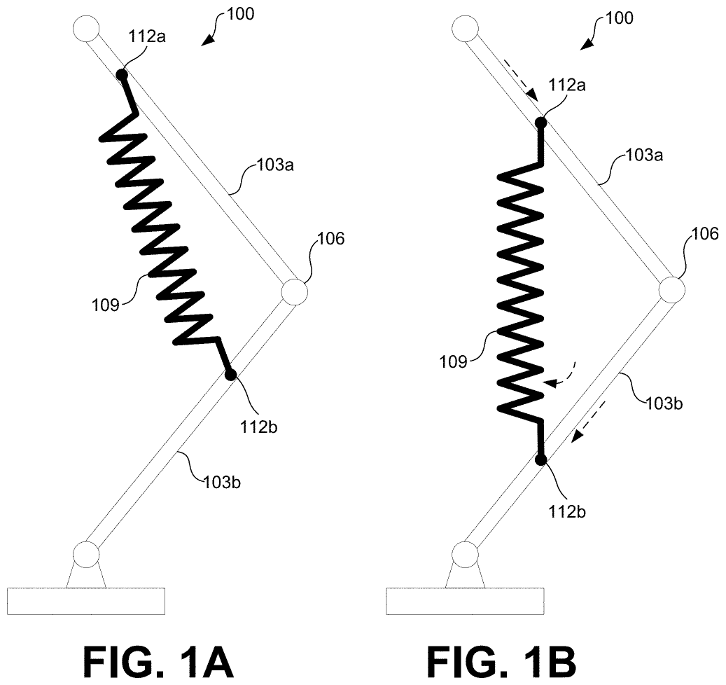

FIGS. 1A and 1B illustrate examples of a variable-stiffness floating spring mechanism 100. The variable-stiffness floating spring mechanism 100 can include two rigid links 103—a first rigid link 103a and a second rigid link 103b—although any suitable configuration of rigid links 103 may be used. The first rigid link 103a can be coupled at one end to an end of the second rigid link 103b using a joint 106. The joint 106 can be any joint or other mechanism that enables flexion and extension of the first rigid link 103a and the second rigid link 103b. The rigid links 103 can be any rigid members capable of flexion and extension without significant deformation.

The variable-stiffness floating spring mechanism 100 can further include a spring 109. The spring 109 can be a constant stiffness spring or other suitable spring. In some implementations, a length of the spring 109 can be lockable to prevent compression or extension of the spring 109 and unlockable to allow compression and extension of the spring 109.

The endpoints 112 of the spring 109 can be coupled to the first rigid link 103a and the second rigid link 103b, respectively. Each of the first endpoint 112a and the second endpoint 112b can slide or otherwise move along a length of the rigid link 103 to which that endpoint 112 is coupled. The endpoints 112 can also be locked to prevent movement of the endpoints along the rigid links 103, such as during compression or extension of the spring 109.

In the example of FIG. 1A, the variable-stiffness floating spring mechanism 100 is shown in a first configuration. In the example of FIG. 1B, the variable-stiffness floating spring mechanism 100 is shown in a second configuration. Moving one or both of the endpoints 112 along the rigid links 103 can allow the configuration of the spring 109 to be changed, thereby changing at least a force-deflection characteristic of the variable-stiffness floating spring mechanism 100. Changing the configuration while the length of the spring 109 is locked can increase or decrease an output force of the variable-stiffness floating spring mechanism 100 at a same output deflection.

For example, locking the length of the spring 109 and changing the configuration of the variable-stiffness floating spring mechanism 100 from the first configuration shown in FIG. 1A to the second configuration shown in FIG. 1B can increase the output force without changing the output deflection. In these examples, the first configuration can be a low stiffness configuration, while the second configuration can be a high stiffness configuration. Thus, changing from the first configuration to the second configuration can increase a stiffness of the variable-stiffness floating spring mechanism 100.

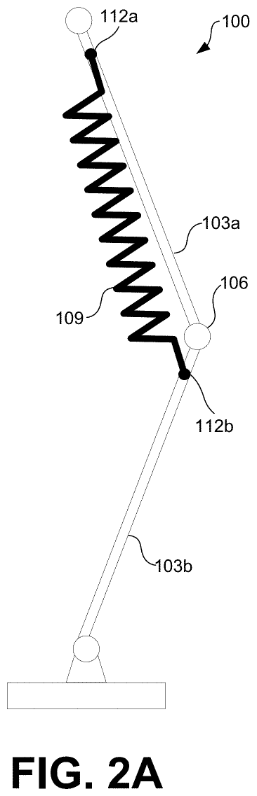

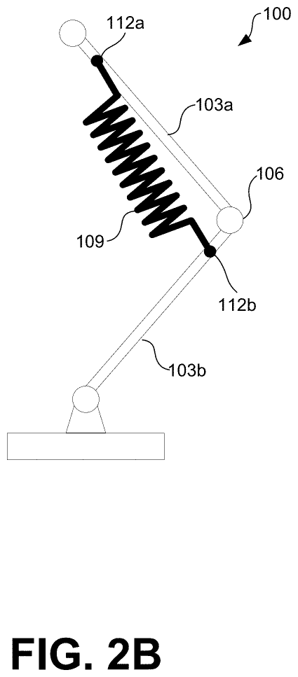

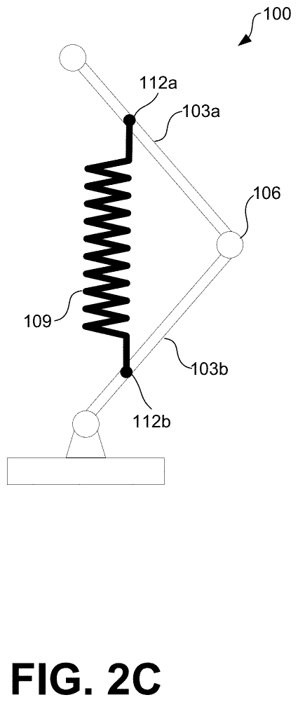

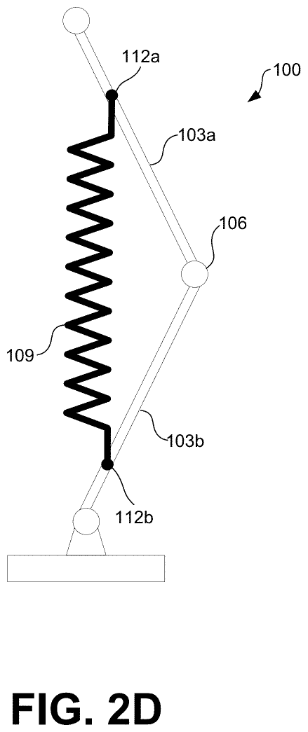

FIGS. 2A-2D illustrate examples of a work cycle of the variable-stiffness floating spring mechanism 100. In the work cycle, the variable-stiffness floating spring mechanism 100 can be compressed, its stiffness can be increased, and it can be extended. This causes the variable-stiffness floating spring mechanism 100 to transition from an extended state with a low stiffness to an extended state with a high stiffness. The work cycle can be performed to increase energy in the spring 109 that can be released following the work cycle. In some examples, the work cycle can be performed multiple times to accumulate energy in the spring 109 before the energy is finally released.

In the example of FIG. 2A, the variable-stiffness floating spring mechanism 100 is shown in a low stiffness configuration with the spring 109 extended. The variable-stiffness floating spring mechanism 100 can be in the state shown in FIG. 2A to begin the work cycle.

In the example of FIG. 2B, the variable-stiffness floating spring mechanism 100 is shown in a low stiffness configuration with the spring 109 compressed. Compared with the example of FIG. 2A, the spring 109 has been compressed in the low stiffness configuration by causing flexion of the rigid links 103 at the joint 106. The endpoints 112 have been locked and the length of the spring 109 has been unlocked (if they were not already), which can allow the spring to be compressed while the variable-stiffness floating spring mechanism 100 remains in a low stiffness configuration. The spring 109 can be compressed until an output deflection reaches a particular value.

In FIG. 2C, the variable-stiffness floating spring mechanism 100 is shown in a high stiffness configuration with the spring 109 compressed. Compared with the example of FIG. 2B, the stiffness of the variable-stiffness floating spring mechanism 100 has been increased. The length of the spring 109 has been locked so that the energy stored by the spring 109 cannot be released while the stiffness is increased. The endpoints 112 have been unlocked so that they may move along the rigid links 103 to increase stiffness. In particular, the first endpoint 112a has been moved along the first rigid link 103a toward the joint 106, and the second endpoint 112b has been moved along the second rigid link 103b away from the joint 106.

In FIG. 2D, the variable-stiffness floating spring mechanism 100 is shown in a high stiffness configuration with the spring 109 extended. Compared with the example of FIG. 2C, the endpoints 112 have been locked and the length of the spring 109 has been unlocked. As a result, the spring 109 has extended while the variable-stiffness floating spring mechanism 100 remains in the high stiffness configuration.

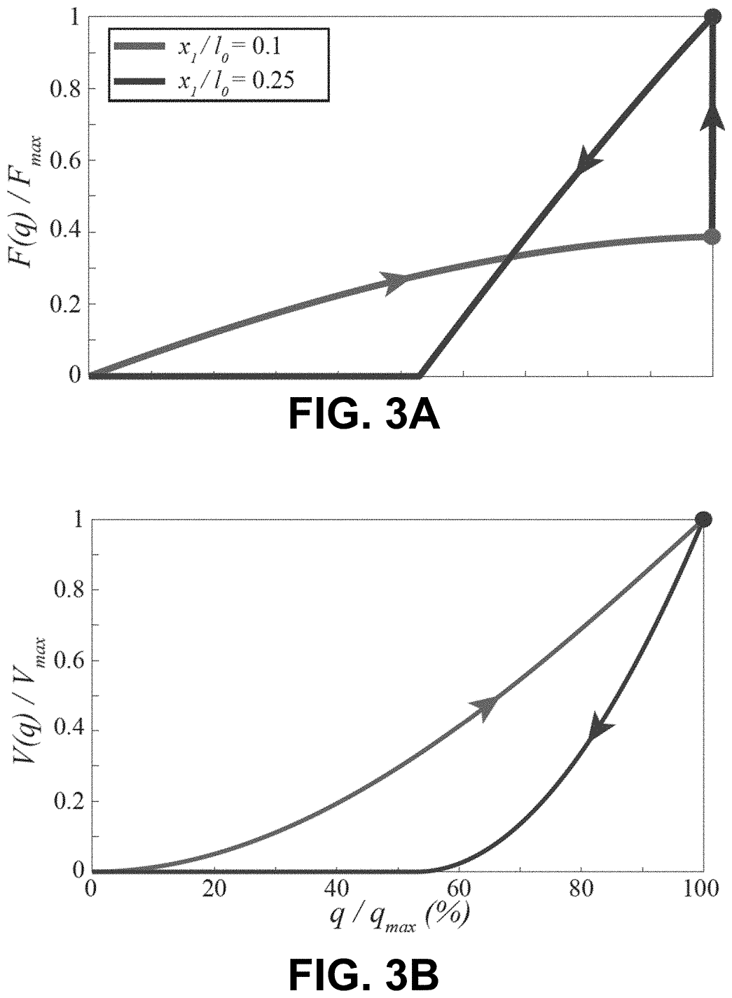

FIGS. 3A and 3B illustrate examples of measurements from the variable-stiffness floating spring mechanism 100 during the work cycle illustrated in FIGS. 2A-2D. FIG. 3A shows a force deflection of the variable-stiffness floating spring mechanism 100 during the work cycle. FIG. 3B shows an energy stored versus a deflection of the variable-stiffness floating spring mechanism 100 during the work cycle.

FIGS. 3A and 3B demonstrate that, during the extension shown in FIG. 2D, the spring 109 can return a same amount of energy that it stored during the compression shown in FIG. 2B, but with a higher force and stiffness. FIGS. 3A and 3B further show that the variable-stiffness floating spring mechanism 100 can be used to change stiffness without changing the energy stored in the spring 109. Because the spring 109 can be locked when the stiffness is changed, as shown in FIG. 2C, the stiffness can be changed by applying a small force to one of the endpoints 112 of the spring 109 without being opposed by the large force in the compressed spring 109. Thus, the energy cost of changing the stiffness can be independent of the energy stored by the spring 109 and the output position.

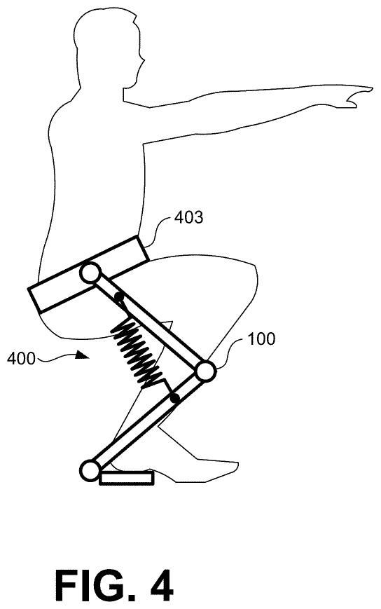

FIG. 4 illustrates an example of a variable-stiffness floating spring exoskeleton 400. The variable-stiffness floating spring exoskeleton 400 can be an energetically passive exoskeleton capable of peak human performance augmentation. For example, the variable-stiffness floating spring exoskeleton 400 can enable effective augmentation of human lower limb force. As another example, the variable-stiffness floating spring exoskeleton 400 can serve as an increasing energy reservoir to store and return greater amounts of energy over cycles of motion like, for example, running.

The variable-stiffness floating spring exoskeleton 400 can include two variable-stiffness floating spring mechanisms 100. Each of these variable-stiffness floating spring mechanisms 100 can be coupled to a brace 403. The brace 403 that can secure the variable-stiffness floating spring exoskeleton 400 to a waist or other part of a human body. The variable-stiffness floating spring mechanisms 100 can likewise each be secured to a leg or other part of a human body.

The variable-stiffness floating spring exoskeleton 400 can enable an output force to be amplified at any given deflection by increasing a stiffness of the variable-stiffness floating spring exoskeleton 400. Thus, the variable-stiffness floating spring exoskeleton 400 can allow an input to include a low force within typical human capability, while an output of the variable-stiffness floating spring exoskeleton 400 can be amplified to a higher assistive force that exceeds human capability.

Because the variable-stiffness floating spring exoskeleton 400 can be energetically passive, the variable-stiffness floating spring exoskeleton 400 can provide a benefit of stiffness adaptation without powerful motors or hefty battery packs, thereby reducing the bulk and weight of the variable-stiffness floating spring exoskeleton 400.

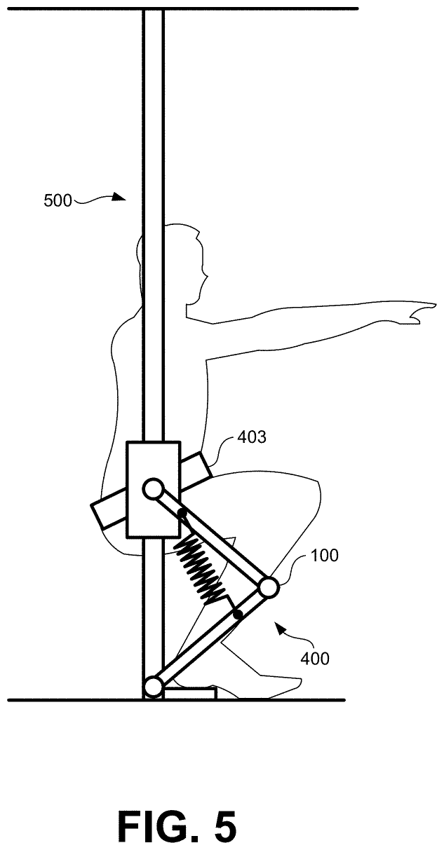

FIG. 5 illustrates an example of the variable-stiffness floating spring exoskeleton 400 in a constrained human-device interface 500. The constrained human-device interface 500 can enable characterization of how the variable-stiffness floating spring exoskeleton 400 interacts with a human user. The constrained human-device interface 500 can constrain the variable-stiffness floating spring exoskeleton 400 to unidirectional motion.

The constrained human-device interface 500 can be, for example, a controlled compression testing apparatus. This apparatus can include a vertically constrained setup of the variable-stiffness floating spring exoskeleton 400 placed on top of force plates that can be used to measure ground reaction forces to determine the force amplification capabilities of the variable-stiffness floating spring exoskeleton 400.

Testing the variable-stiffness floating spring exoskeleton 400 while motion is constrained can eliminate confounding issues, such as stability corrections by the human user. This can allow the force-deflection behavior and energy storage capacity of the variable-stiffness floating spring exoskeleton 400 to be assessed with changing stiffness settings. The modes of assistance that the variable-stiffness floating spring exoskeleton 400 provides to the human user can be examined using ground reaction force data, muscle electromyography data, lower limb joint torque data, center of mass velocity, and acceleration data, or other suitable data.

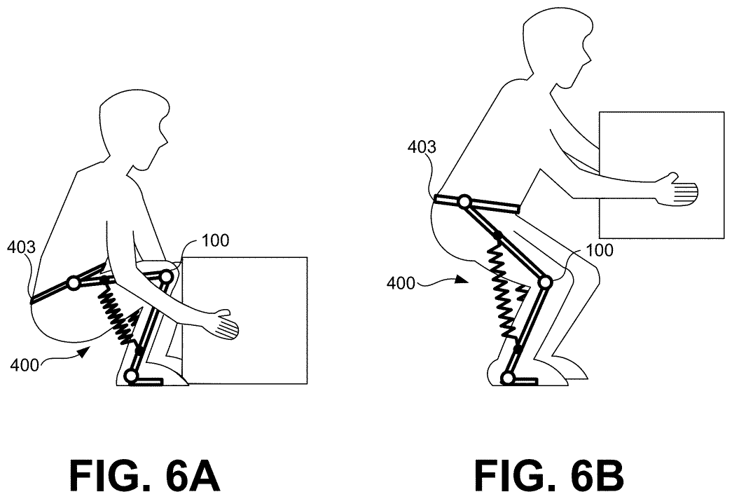

FIGS. 6A and 6B illustrate an example of the variable-stiffness floating spring exoskeleton 400 used in an exemplary task. These examples show an unconstrained lifting task using the variable-stiffness floating spring exoskeleton 400. FIG. 6A shows an input of squatting to reach a heavy object—a low-force input within typical human capability. FIG. 6B shows an output of lifting the heavy object that can be amplified to a higher assistive force that can allow the heavy object to be lifted.

Thus, the variable-stiffness floating spring exoskeleton 400 can allow a human user to lift heavier objects than the human user would typically be capable. For example, the human user can lift progressively heavier objects until the human user is no longer able to do so. A difference in a maximum load lifting with and without the variable-stiffness floating spring exoskeleton 400 can be a measure of a human force augmentation from using the variable-stiffness floating spring exoskeleton 400.

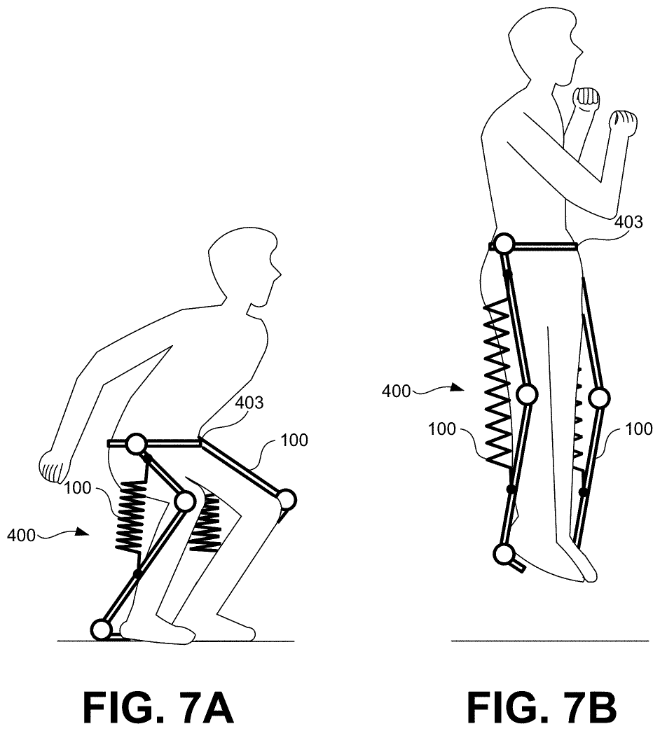

FIGS. 7A and 7B illustrate an example of the variable-stiffness floating spring exoskeleton 400 used in another exemplary task. These examples show an unconstrained jumping task using the variable-stiffness floating spring exoskeleton 400. FIG. 7A includes an example of an input of squatting in preparation for a jump—a low-force input within typical human capability. FIG. 6B includes an example of an output of a jump that can be amplified to a higher assistive force that can allow the human user to perform a high jump.

Thus, the variable-stiffness floating spring exoskeleton 400 can allow a human user to jump higher than the human user is physically capable. As an example, the human user can perform successive squats or jumps while changing a stiffness of the variable-stiffness floating spring exoskeleton 400 between squats or jumps. As another example, the human user could perform the work cycle described in FIGS. 2A-2B multiple times to accumulate energy in the variable-stiffness floating spring exoskeleton 400 before the energy can be finally released in a high jump. An increase in jump height can show the variable-stiffness floating spring exoskeleton's 400 capability as an increased energy storage reservoir with increasing stiffness.

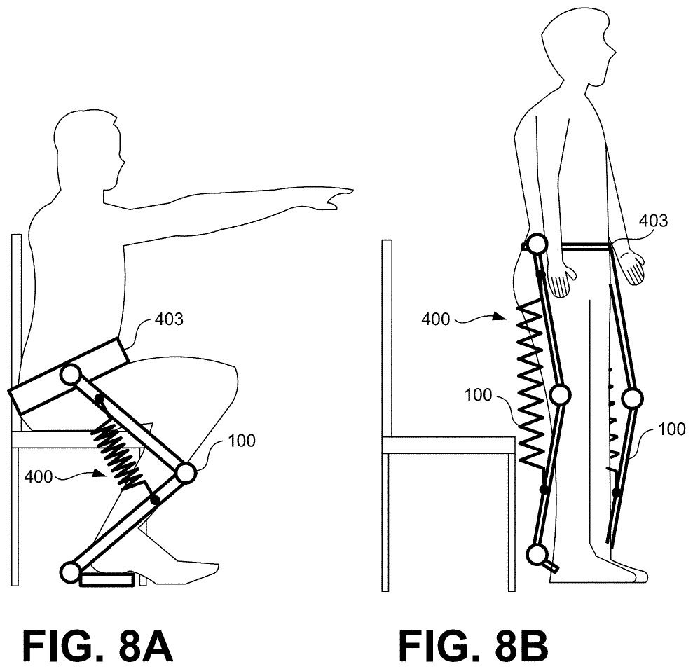

FIGS. 8A and 8B illustrate an example of the variable-stiffness floating spring exoskeleton 400 used in another exemplary task. The example shows an unconstrained sit-to-stand task using the variable-stiffness floating spring exoskeleton 400. FIG. 8A shows the human use sitting down, which uses a low force within typical human capability. FIG. 8B shows the human user standing up where the exoskeleton can provide a higher assistive force that can allow the human user to stand up using less effort than normal.

Thus, the variable-stiffness floating spring exoskeleton 400 can allow a human user to stand up even if the human would be unable to do so unassisted. For example, while the human can increase the stiffness of the variable-stiffness floating spring exoskeleton 400 and stand up.

A phrase, such as “at least one of X, Y, or Z,” unless specifically stated otherwise, is to be understood with the context as used in general to present that an item, term, etc., can be either X, Y, or Z, or any combination thereof (e.g., X, Y, and/or Z). Similarly, “at least one of X, Y, and Z,” unless specifically stated otherwise, is to be understood to present that an item, term, etc., can be either X, Y, and Z, or any combination thereof (e.g., X, Y, and/or Z). Thus, as used herein, such phrases are not generally intended to, and should not, imply that certain embodiments require at least one of either X, Y, or Z to be present, but not, for example, one X and one Y. Further, such phrases should not imply that certain embodiments require each of at least one of X, at least one of Y, and at least one of Z to be present.

Although embodiments have been described herein in detail, the descriptions are by way of example. The features of the embodiments described herein are representative and, in alternative embodiments, certain features and elements may be added or omitted. Additionally, modifications to aspects of the embodiments described herein may be made by those skilled in the art without departing from the spirit and scope of the present disclosure defined in the following claims, the scope of which are to be accorded the broadest interpretation so as to encompass modifications and equivalent structures.

Therefore, at least the following is claimed:

1. An apparatus comprising:
a first rigid link;
a second rigid link coupled to the first rigid link by a joint; and
a spring movably attached at a first endpoint of the spring to the first rigid link and movably attached at a second endpoint to the second rigid link.

2. The apparatus of claim 1, wherein moving the spring from an upper configuration to a lower configuration increases or decreases an output force at a same output deflection.

3. The apparatus of claim 1, wherein:
a length of the spring is lockable,
the first endpoint is lockable to the first rigid link, and
the second endpoint is lockable to the second rigid link.

4. The apparatus of claim 3, wherein the spring is configured to extend from a compressed state in response to the first endpoint being locked to the first rigid link, the second endpoint being locked to the second rigid link, and the length of the spring being locked.

5. The apparatus of claim 1, wherein the spring comprises a fixed-stiffness spring.

6. The apparatus of claim 1, wherein the first endpoint is movable along a length of the first rigid link and the second endpoint is movable along a length of the second rigid link.

7. A variable-stiffness floating spring mechanism, comprising:
a first link;
a second link;
a joint coupled to the first link and the second link; and
a spring coupled at an upper end to the first link and coupled at a lower end to the second link.

8. The variable-stiffness floating spring mechanism of claim 7, wherein the spring has a constant stiffness.

9. The variable-stiffness floating spring mechanism of claim 7, wherein the variable-stiffness floating spring mechanism is attachable to a human limb.

10. The variable-stiffness floating spring mechanism of claim 7, wherein the variable-stiffness floating spring mechanism is compressible in a high stiffness configuration or a low stiffness configuration.

11. The variable-stiffness floating spring mechanism of claim 7, wherein the variable-stiffness floating spring mechanism is extendible in a high stiffness configuration or a low stiffness configuration.

12. The variable-stiffness floating spring mechanism of claim 7, wherein an energy cost of changing a stiffness of the variable-stiffness floating spring mechanism is independent of an energy stored by the spring.

13. The variable-stiffness floating spring mechanism of claim 7, wherein the spring is lockable to the first link and to the second link.

14. The variable-stiffness floating spring mechanism of claim 7, wherein a length of the spring is lockable.

15. The variable-stiffness floating spring mechanism of claim 7, wherein the spring is movable along the first link and along the second link.

16. A method, comprising:
causing a compression of a variable-stiffness floating spring mechanism in a first stiffness configuration;
causing a transition of the variable-stiffness floating spring mechanism from the first stiffness configuration to a second stiffness configuration, the transition increasing a stiffness of the variable-stiffness floating spring mechanism; and
causing an extension of the variable-stiffness floating spring mechanism in the second stiffness configuration.

17. The method of claim 16, wherein the variable-stiffness floating spring mechanism comprises a spring, a first endpoint, a second endpoint, a first rigid link, and a second rigid link.

18. The method of claim 17, wherein causing the compression of the variable-stiffness floating spring mechanism in the first stiffness configuration further comprises:
locking the first endpoint of the spring in an upper position on the first rigid link;
locking the second endpoint of the spring in an upper position on the second rigid link; and
compressing the spring.

19. The method of claim 17, wherein causing the transition of the variable-stiffness floating spring mechanism from the first stiffness configuration to the second stiffness configuration further comprises:
locking a length of the spring;
unlocking the first endpoint of the spring from an upper position on the first rigid link;
unlocking the second endpoint of the spring from an upper position on the second rigid link;
moving the first endpoint of the spring from the upper position on the first rigid link to a lower position on the first rigid link; and
moving the second endpoint of the spring from the upper position on the second rigid link to a lower position on the second rigid link.

20. The method of claim 17, wherein causing the extension of the variable-stiffness floating spring mechanism in the second stiffness configuration further comprises:
locking the first endpoint of the spring in a lower position on the first rigid link;
locking the second endpoint of the spring in a lower position on the second rigid link; and
unlocking a length of the spring, wherein unlocking the length of the spring causes the spring to extend.
